(19) United States
(12) Patent Application Publication
(10) Pub. No.: US 2004/0146432 A1
(43) Pub. Date: Jul. 29, 2004

(54) Gas detection apparatus and method utilizing an integral temperature correction device

(76) Inventors: Charles E. Loomis, Tampa, FL (US); Bryan I. Truex, Belleair Beach, FL (US)

Correspondence Address: PAULA D. MORRIS & ASSOCIATES, P.C., 10260 WESTHEIMER, SUITE 360, HOUSTON, TX, 77042, US

(21) Appl. No.: 10/453,802

(22) Filed: Jun. 3, 2003

Related U.S. Application Data
(60) Provisional application No. 60/385,416, filed on Jun. 3, 2002.

(51) Int. Cl. G01N 31/22

(52) U.S. Cl. 422/86; 422/59

(57) ABSTRACT

An apparatus for measuring the concentration of a target substance is provided. The apparatus includes a detection container, a pump, and an integral temperature indicator or integral temperature correction factor indicator. The detection container has or contains a detection material chemically reactive with the target substance to produce an observable indication upon exposure to the target substance and such that the concentration of the target substance detected is readable from the observable indication. The pump is engageable with the detection container and operable to draw a sample of a gaseous environment into the detection container, the drawn sample containing the target substance, such that the detection material is exposed to the target substance. As for the integral temperature correction factor indicator, it is particularly adapted to indicating the correction factor applicable to the concentration measurement at specific temperatures.

The present invention claims the benefit of the filing date of Provisional Application Serial No. 60/385,416 filed Jun. 3, 2002. This priority document is hereby incorporated by reference for all purposes and made a part of the present disclosure.

### BACKGROUND OF THE INVENTION

The present invention relates generally to an apparatus and a method for detecting the presence of a target substance in a gaseous environment. More particularly, the invention relates to such an apparatus and method for measuring the concentration of the target substance. In one aspect of the invention, the method employs an integral temperature indicator and/or correcting device to account for temperature variations.

### SUMMARY OF THE INVENTION

The present invention is directed to an apparatus and a method for measuring the concentration of a target substance. In one aspect of the invention, the inventive apparatus includes a detection container, a pump, and an integral temperature indicator or integral temperature correction factor indicator. Preferably, the detection container has or contains a detection material that is chemically reactive with the target substance to produce an observable indication upon exposure to the target substance and such that the concentration of the target substance detected is readable from the observable indication. The pump is engageable with the detection container and operable to draw a sample of a gaseous environment into the detection container, the drawn sample containing the target substance, such that the detection material is exposed to the target substance. More preferably, the temperature indicator is integrally located about the detection container or the pump, and most preferably, on the outer surface of the pump.

In one aspect of the invention, an integral temperature correction factor indicator is provided for indicating the correction factor applicable to the concentration measurement at specific temperatures. The temperature correction indicator may be provided in addition to or in lieu of the temperature indicator. In one embodiment, temperature indications are provided in addition to temperature correction factor indications and are located so as to correspond with a matching temperature correction factor indicator. Preferably, each correction factor indicator (or temperature indicator) is adapted to illuminate in response to a specific temperature. Thus, in a method according to the invention, the user obtains both the concentration of the target substance and the appropriate temperature correction factor from the apparatus. By applying the correction factor to the measured or indicated concentration, the user obtains the proper or corrected concentration of the detected target substance.

### BRIEF DESCRIPTION OF THE DRAWINGS

For a more complete understanding of the present invention, reference is now made to the following descriptions taken in conjunction with the accompanying drawing, in which:

FIG. 1 is a simplified diagram depicting a gas detection apparatus according to the present invention;

FIG. 1A is a simplified diagram depicting a detector tube for use with the apparatus of FIG. 1;

FIG. 2 is a cross sectional view across line 2-2 in FIG. 1 depicting an integral temperature indicator for use with the apparatus of FIG. 1;

FIG. 3 is a simplified diagram of an alternative gas detection apparatus according to the invention; and

FIGS. 4A-4B are simplified diagrams of an alternative gas detection apparatus according to the present invention; and

FIG. 5 is an alternative thermostrip with temperature correction factor indications provided thereon, according to the present invention.

### DETAILED DESCRIPTION OF THE INVENTION

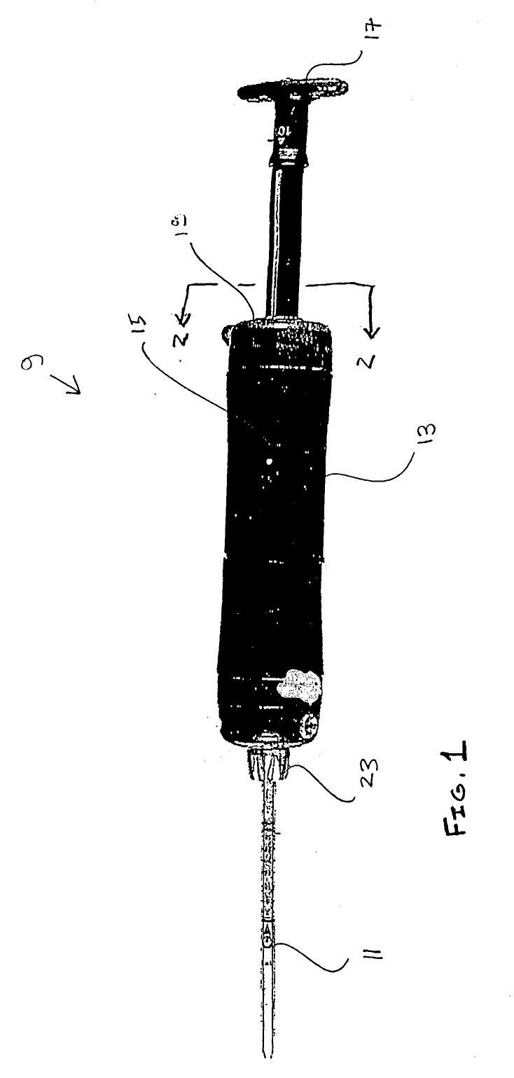

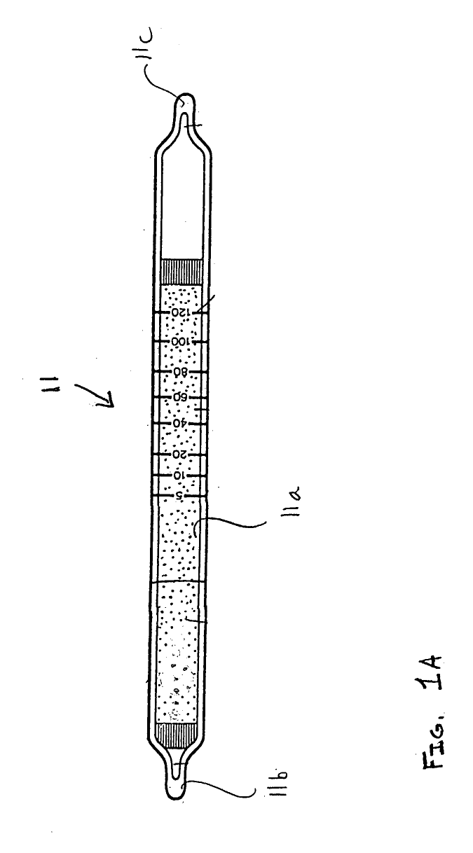

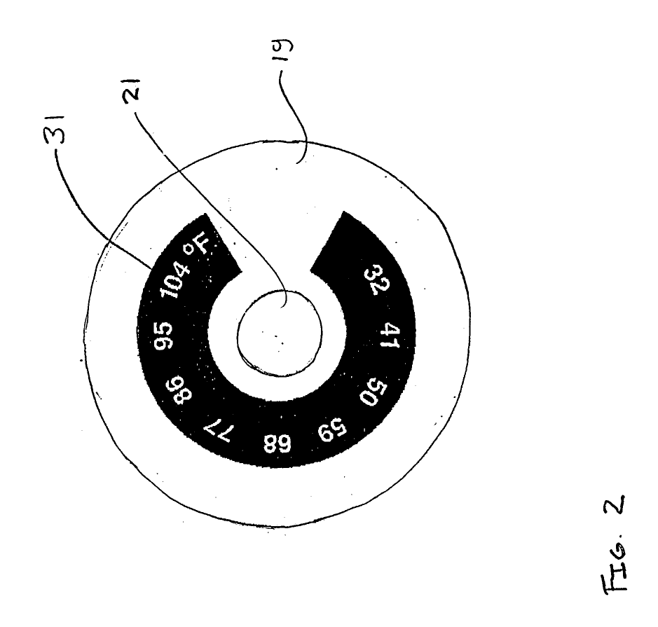

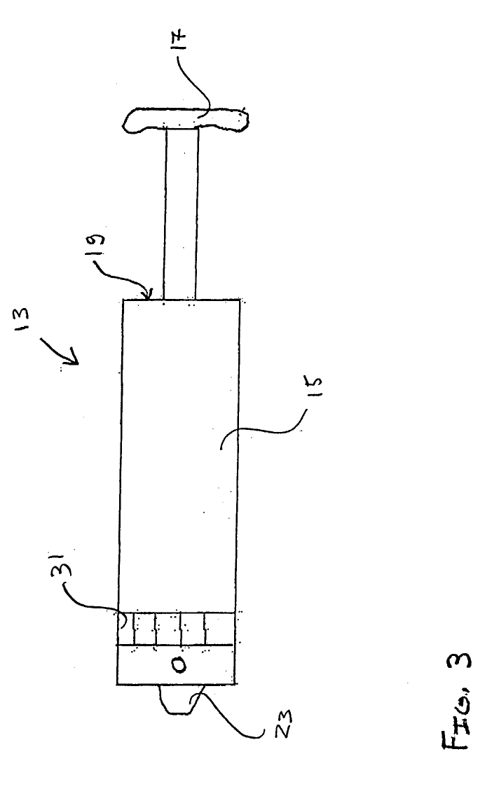

FIGS. 1-2 depict an apparatus for detecting a target substance embodying various aspects of the present invention. FIG. 3 depicts an alternative embodiment of the inventive apparatus. The inventive apparatus and method are employable to detect the concentration of the target substance in a local gaseous environment, and providing an observable indication of the concentration detected. Further, the inventive apparatus and method provide a means for detecting the concentration of the target substance and providing an indication that is correctable for temperature variations attributed to the local gaseous environment in which the substance is detected. In several embodiments, the temperature indicator is located integrally with (e.g., incorporated therewith) one of the basic components of the gas detection apparatus.

As used herein, the term “detected” or “detection” is used to refer to a primary function or result of the inventive method. More specifically, the inventive apparatus is used to “detect” the presence of or a concentration of the target substance. However, detection of the target substance preferably includes providing a measure of the amount or concentration detected and readily communicating this measurement to the user (e.g., by a color change or other observable indication).

It should first be noted that, upon review of the detailed description of the drawings provided herein, it will become apparent to one ordinarily skilled in the relevant art (e.g., the instrumentation or measurement art) that the various aspects of the present invention may be applicable to other means for detecting a target substance in a local gaseous environment. The focus of the present description is an application to a gas detection system employing a detection tube and a manual piston type pump. It should become apparent, however, that the temperature correction device may be applied to other gas or target substance detection systems. Accordingly, the application of the invention is not limited to a detection system that employs a detection tube and/or utilizes a manual piston type pump. Thus, the present invention is not intended to be limited to the structures and methods specifically described and illustrated herein.

Referring to FIG. 1, the present invention is particularly applicable to a gas detection system or apparatus 9 employing a detection tube 11 with a manual piston sampling pump 13. Such a system may be, for example, one of several commercially available piston-type designs including those marketed as the Gastec, Kitagawa, and Rae detector tube systems or one of several commercially-available bellows-type designs marketed by or as Draeger or MSA detector tube system. In the present invention, however, this basic system or apparatus 9 is modified to incorporate a temperature correction device and/or temperature indicator that allows for correction of field measurements. As shown in FIG. 1A, the detector tube 11 is preferably a thin glass tube with calibration scales printed thereon, by which an operator can directly read concentrations of the substances (gases or vapors) to be measured. Each tube contains a detecting material or reagent 11a that is selected because of its sensitivity to the target substance and because it produces a distinct layer of color change upon exposure to the target substance. The detector tube 11 is typically packaged with hermetically sealed ends 11b, 11c that may be broken or severed during operation, or may be provided in series connection with another detection tube. As will be discussed below, the detection tube 11 may be engaged by a pump 13 so as to provide a field carryable unit for sampling a local gaseous environment.

As is known in the art, the detection tube 11 holds or houses a quantity of detection material 11a. Upon exposure to the target substance, the detection material 11a reacts calorimetrically with the target substance to produce an observable and measurable color change. In alternative embodiments, the detection material may be an electrochemical sensor or other material chemically reactive with the target substance.

Manual piston-type sampling pumps such as the pump 13 depicted in FIG. 1 are known to be used with a gas detection apparatus. It should be noted, however, that other type pumps may be used with the inventive gas detection apparatus including a manual bulb-type pump. The pump 13 includes a cylinder body 15 having a grippable outer surface and a piston handle 17. The pump includes a first end or detector end 23 for engaging the detector tube 11 and a second end 19 accommodating the travel or stroke of the piston. The handle end 19 of the pump includes a generally radial surface oriented perpendicularly to the longitudinal axis of the pump 13. Situated centrally on this radial surface is a bore 21 in which the piston travels, as also shown in FIG. 2

By operating the manual pump 13, the user draws gas into the detector tube 11 causing the required colorimetric reaction. As a result, color change occurs in the detection material in the form of an observable stain. The intensity or length of the stain is representative of the concentration of the target substance detected and is measurable using the calibrated scale on the tube 11.

Applicants have discovered, however, that such a chemical reaction is particularly sensitive to the temperature of the gas. Due to inherent temperature effects on chemical reactivity (typically slower reactions at lower temperatures), the length or intensity of stain is directly affected by temperature due to more or less material reacting with the target gas, relative to the temperature sensitivity of the chemicals involved. It is for this reason that some detector tubes may have a large difference in the length of stain relative to temperature, while others may have little or no effect. Thus, obtaining accurate measurements often requires correcting for the temperature of the local gaseous environment sampled and then applying a correction factor to the reading of the concentration. For this purpose, correction charts or sheets are often provided with the gas detection device. These so called correction charts may be specifically generated depending on the target substance and the detector tube design. In any event, the operator must also determine the temperature upon which the sampling or measurement occurs. With prior art systems and methods, it is often difficult to provide this temperature correction because users of the gas detection device often do not to carry a thermometer with them in the field. Accordingly, inaccurate measurements or readings are commonplace.

FIG. 2 illustrates a temperature indicating strip or label intended for use with the present inventive gas detection apparatus. Temperature indicating strips or thermostrips are available in polyester (Mylar) construction that uses microencapsulated liquid crystal color changing inks to indicate a specific temperature or range. These thermostrips are commercially available but are available only as elongated strips with temperature indications thereon. Typical applications of these strips are found in consumer products, medical laboratory products, and in advertising.

In the present invention, the thermostrips have been modified to come in an alternate form or configuration, which are particularly and uniquely advantageous in gas measuring applications. As shown in FIG. 2, a preferred design is a circular design wherein the temperature indications are arranged in a circular pattern. The thermostrip 31 has a “doughnut” shape which includes a central hole and a gap in the circular pattern. As a result, the circular thermostrip 31 may be placed conveniently and advantageously at a preferred location on the manual pump 13. Specifically, the circular thermostrip 31 may be advantageously placed on the handle surface 19 of the pump 13, as shown in FIG. 2. At this location, the temperature indicators may be easily and conveniently read by the user, while the user is operating the handle 21. Moreover, this surface or area of the pump 13 is less likely to come in contact with the user's hands or other external surfaces.

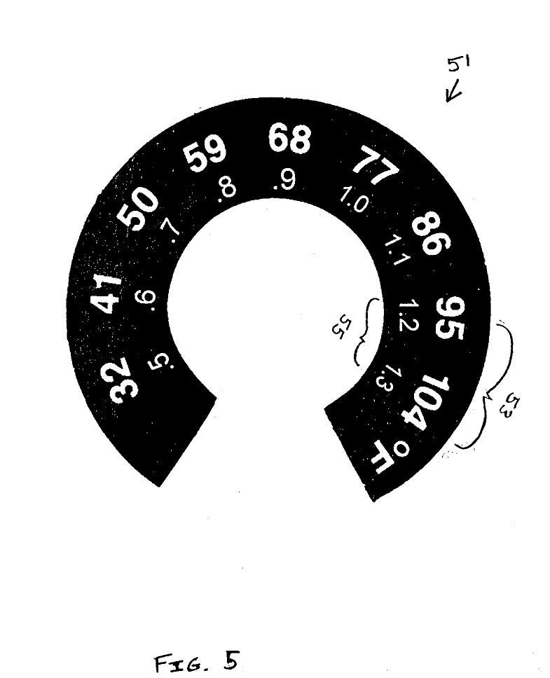

Alternatively, the thermostrip 31 may be placed circumferentially or may be placed around the circumferential surface of the pump body 15, as is shown in FIG. 3. In such an application, the thermostrip is elongated but the temperature indicators are arranged in a linear pattern. In an alternative embodiment of the thermostrip as shown in FIG. 5, the thermostrip 51 is modified to include correction factor indications 55. Such correction factors are normally provided on a separate correction charge. The thermostrip 51 provides the correction factor indications 55 in a circular pattern, which correspond to temperature indications 53. Thus, the user can simply take the correction factor from the gas detection device rather than consulting a correction sheet. This is yet another aspect of the inventive apparatus and method. In yet another alternative embodiment, the thermostrip may be provided with correction factor indications 55, but not the temperature indications 53. In this embodiment, the appropriate correction factor may illuminate to prompt the user. In the previous embodiment, the temperature indications may illuminate (i.e., to indicate the relevant temperature), so that the user is directed to the correction factor positioned adjacent the illuminated temperature indication. Thus, the user can simply take the correction factor from the gas detection device rather than consulting a correction sheet. This is yet another aspect of the inventive apparatus and method.

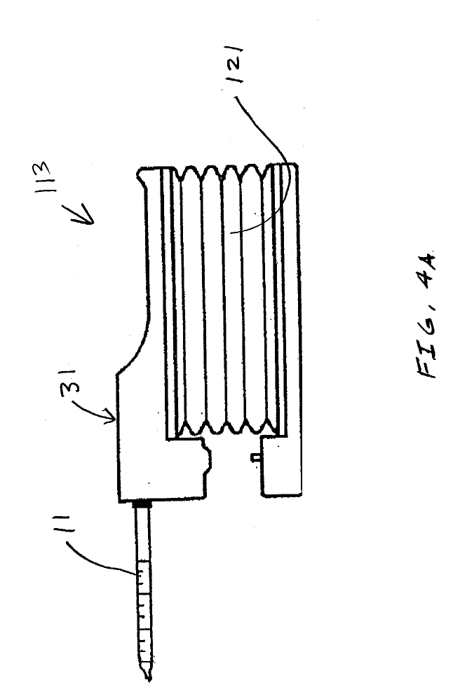

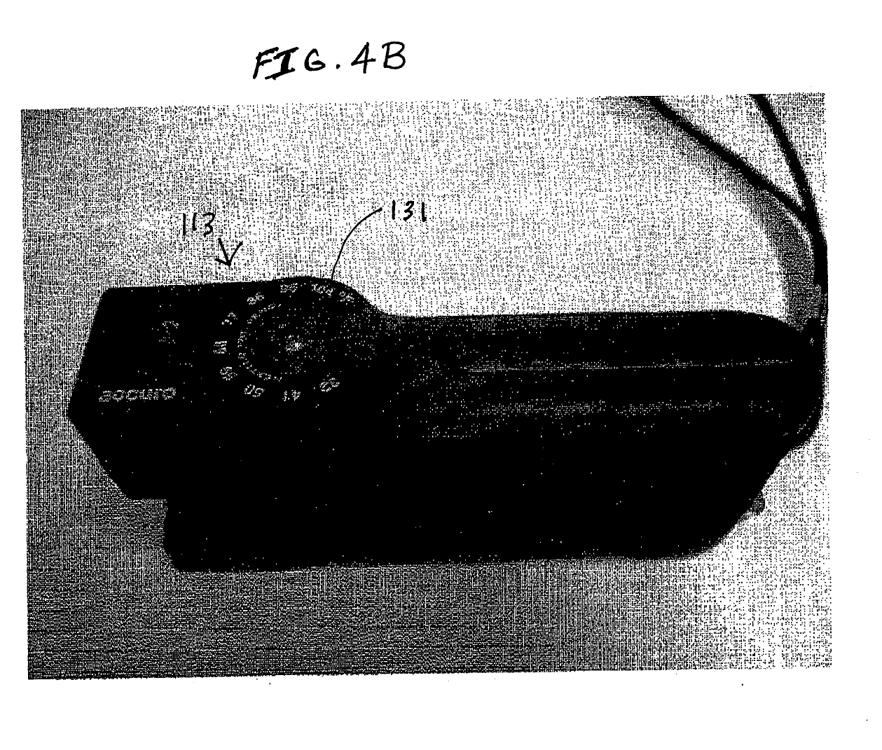

FIGS. 4a and 4b depict yet another embodiment of the gas detection system or apparatus according to the invention. In this embodiment, a bellows-style pump 113 is used in combination with a detector tube. The manual bellows-style sampling pump 113 performs a similar function as that of the manual piston-type pump of FIG. 3, but requires squeezing of the accordian-style bellows 121 to force air to discharge (while simultaneously drawing air through the tube). FIG. 4 illustrates an alternative placement of a thermostrip 131 on a different location on the pump and on a different style pump. In FIG. 4b, the thermostrip 131 is shown advantageously placed on a top surface of the pump 113.

Various embodiments of the present invention have been described herein. It should be understood by those of ordinary skill in the art, however, that the above-described embodiments, such as an apparatus employing a gas detector tube and a standard detector tube and manual piston pump, are set forth merely by way of example and should not be interpreted as limiting the scope of the invention, which is defined by the appended claims. Other alternative embodiments, variations and modifications of the foregoing embodiments that embrace various aspects of the present invention will also be understood upon a reading of the detailed description in light of the prior art. For instance, it will be understood that application of a thermostrip or the various types and configurations of thermostrips, may be combined with features of other embodiments while many other features may be omitted or replaced (e.g., the manual pump, as being non-essential to the practice of the present invention).

What is claimed is:

1. An apparatus for measuring the concentration of a target substance, said apparatus comprising:
a detection container containing a detection material chemically reactive with the target substance to produce an observable indication upon exposure to the target substance, the concentration of the target substance detected being readable from the observable indication;
a pump engageable with the detection container and operable to draw a sample of a gaseous environment into the detection container, the drawn sample containing the target substance, such that the detection material is exposed to the target substance; and
an integral temperature indicator for indicating the temperature of the gaseous environment.

2. The apparatus of claim 1, wherein the detection material is colorimetrically reactive with the target substance to produce an observable color change, the concentration of the detected target substance being readable from the intensity of the color change.

3. The apparatus of claim 1, wherein the temperature indicator is integrally located about the detection container or the pump.

4. The apparatus of claim 1, wherein the temperature indicator is integrally located on an outer surface of the pump.

5. The apparatus of claim 1, wherein the pump has a cylindrical body with a circumferential surface, the temperature indicator being located circumferentially about the circumferential surface.

6. The apparatus of claim 1, wherein the pump has a generally cylindrical body with a piston positioned therein and movable along a longitudinal axis of the body, the pump further having a first end for engaging the detection container and a handle end, the handle end including a bore in which a cylinder piston travels, and the piston including an external piston handle operable by the user of the apparatus.

7. The apparatus of claim 6, wherein the handle end includes a generally radial surface extending radially outward from the bore, and
wherein the temperature indicator has a generally circular configuration, the temperature indicator being located on the radial surface and positioned about the bore.

8. The apparatus of claim 1, wherein the temperature indicator has temperature correction factors provided thereon.

9. The apparatus of claim 1, wherein the temperature indicator is a polyester strip including a microencapsolated liquid crystal color changing inks for indicating temperature.

10. The apparatus of claim 1, wherein the temperature indicator includes temperature correction indicators, each correction indicator being located to correspond with a temperature indicator.

11. The apparatus of claim 1, wherein the temperature indicator includes a plurality of temperature indications, each temperature indication being thermally responsive so as to illuminate in response to a specified temperature.

12. An apparatus for measuring the concentration of a target substance, said apparatus comprising:
a detection container having a detection material chemically reactive with the target substance to produce an observal indication upon exposure to the target substance, the concentration of the target substance detected being readable from the observable indication;
a pump engageable with the detection container and operable to draw a sample of a gaseous environment into the detection container, the drawn sample containing the target substance, such that the detection material is exposed to the target substance; and
an integral temperature correction factor indicator for indicating the correction factor applicable to the concentration measurement at specific temperatures.

13. The apparatus of claim 12, wherein the detection material is calorimetrically reactive with the target substance to produce an observable color change, the concentration of the detected target substance being readable from the intensity of the color change.

14. The apparatus of claim 12, wherein the temperature correction factor indicator is integrally located about the detection container or the pump.

15. The apparatus of claim 12, wherein the temperature correction factor indicator is integrally located on the outer surface of the pump.

16. The apparatus of claim 12, wherein the pump has a cylindrical body with a circumferential surface, the temperature correction factor indicator being located circumferentially about the circumferential surface.

17. The apparatus of claim 12, wherein the pump has a generally cylindrical body with a piston positioned therein and movable along a longitudinal axis of the body, the pump further having a first end for engaging the detection container and a handle end, the handle end including a board in which a cylinder piston travels, and the piston including an external piston handle operable by the user of the apparatus.

18. The apparatus of claim 1, wherein the temperature correction factor indicator includes temperature indicators thereon, the temperature correction factor indicator including temperature indications located so as to correspond with a matching temperature correction factor indicator.

19. The apparatus of claim 12, wherein the temperature correction factor indicator includes a plurality of correction factors, each correction factor being adapted to illuminate in response to a specific temperature.

20. A method of measuring the concentration of a target substance in the field, the method comprising the steps of:
providing an apparatus for detecting the presence of the target substance, the apparatus including:
a detection container having a detection material chemically reactive with the target substance to produce an observable indication upon exposure to the target substance, the concentration of the target substance detected being readable from the observable indication; and
a pump engaged with the detection container and operable to draw a sample of a gaseous environment into the detection container, the drawn sample containing the target substance, such that the detection material is exposed to the target substance; and
applying, integrally with the apparatus, a temperature correction factor indicator for indicating the correction factor applicable to the concentration measurement at specific temperatures;
operating the pump of the apparatus in the field to detect the presence of a concentration of the target substance;
obtaining, from the apparatus, an indicated measurement of the detected concentration;
obtaining, from the apparatus, an indicated temperature correction factor to be applied to the indicated measurement; and
applying the correction factor to the indicated measurement to obtain the corrected concentration of the detected target substance.

21. The method of claim 20, wherein the step of applying the temperature correction factor indicator includes applying the indicator about the outer surface of the pump.

22. The method of claim 20, wherein the step of obtaining an indicated temperature correction factor includes illuminating a predetermined temperature correction factor indication upon detection of a corresponding predetermined temperature.
